(19) United States
(12) Patent Application Publication
(10) Pub. No.: US 2026/0046562 A1
(43) Pub. Date: Feb. 12, 2026

(54) SOUND OUTPUT DEVICES

(71) Applicant: SHENZHEN SHOKZ CO., LTD., Shenzhen (CN)

(72) Inventors: Jianing LIANG, Shenzhen (CN); Zhen WANG, Shenzhen (CN); Chong WANG, Shenzhen (CN); Lei ZHANG, Shenzhen (CN); Xin QI, Shenzhen (CN)

(73) Assignee: SHENZHEN SHOKZ CO., LTD., Shenzhen (CN)

(21) Appl. No.: 19/359,640

(22) Filed: Oct. 15, 2025

Related U.S. Application Data
(63) Continuation of application No. PCT/CN2024/095481, filed on May 27, 2024.

(51) Int. Cl. H04R 3/08; H04R 1/10; H04R 1/24; H04R 9/02; H04R 9/06

(52) U.S. Cl. CPC H04R 3/08; H04R 1/105; H04R 1/24; H04R 9/025; H04R 9/06

(57) ABSTRACT

A sound output device is provided. The sound output device includes: a first speaker configured to generate a sound in a first frequency band in response to receiving a first electrical signal; a frequency-dividing circuit configured to perform a frequency division process on an excitation signal to generate the first electrical signal, wherein the frequency-dividing circuit is configured to: suppress signal components of the excitation signal with frequencies lower than a frequency-dividing frequency, so that a signal component of the first electrical signal with a frequency lower than a sound breaking frequency of the first speaker is attenuated by a preset amplitude compared to a signal component of the excitation signal with a frequency lower than the sound breaking frequency; a housing configured to accommodate the first speaker and the frequency-dividing circuit; and a support structure configured to place the housing at a position near an ear canal opening of a user without blocking the ear canal opening of the user.

### CROSS-REFERENCE TO RELATED APPLICATION

The present application is a continuation of International Application No. PCT/CN2024/095481, filed on May 27, 2024, the entire content of which is hereby incorporated by reference.

### TECHNICAL FIELD

The present disclosure relates to the field of acoustic technology, and in particular to a sound output device.

### BACKGROUND

With the development of acoustic technology, acoustic devices (e.g., earphones) have been widely used in people's daily lives. An acoustic device has the potential to output sound using a combination of a plurality of speakers to facilitate the provision of an auditory feast for a user. When used in combination, different speakers may be responsible for respectively outputting the sound with different frequency bands. In general, the speakers that emit sounds with different frequency bands are driven by a single electrical signal or multiple electrical signals. When the single electrical signal is used to drive the speakers, since a diaphragm of the speaker responsible for outputting the sound in a high-frequency band is usually thinner, there may be a sound break due to too great an amplitude when the diaphragm receives a low-frequency signal, which affecting listening quality and user experience.

Therefore, it is necessary to provide a sound output device to avoid or reduce the phenomenon of sound breakage caused by the speaker responsible for outputting the sound in a high-frequency band in response to receiving a low-frequency electrical signal, thereby offering users a better listening experience.

### SUMMARY

Some embodiments of the present disclosure provide a sound output device including: a first speaker configured to generate a sound in a first frequency band in response to receiving a first electrical signal; a frequency-dividing circuit configured to perform a frequency division process on an excitation signal to generate the first electrical signal, and the frequency-dividing circuit is configured to: suppress signal components of the excitation signal with frequencies lower than a frequency-dividing frequency, so that a signal component of the first electrical signal with a frequency lower than a sound breaking frequency of the first speaker is attenuated by a preset amplitude compared to a signal component of the excitation signal with a frequency lower than the sound breaking frequency; a housing configured to accommodate the first speaker and the frequency-dividing circuit; and a support structure configured to place the housing at a position near an ear canal opening of a user without blocking the ear canal opening of the user.

Some embodiments of the present disclosure provide a sound output device including a first speaker configured to output a sound of a first frequency band, the first speaker including a first diaphragm, wherein a first front cavity and a first rear cavity are disposed on both sides of the first diaphragm along a vibration direction of the first diaphragm, respectively, and the first front cavity of the first speaker is in communication with an outside of the sound output device through a first sound guiding hole; a second speaker configured to output a sound of a second frequency band, a frequency of the second frequency band being smaller than a frequency of the first frequency band, a second front cavity and a second rear cavity are disposed on both sides of the second diaphragm along a vibration direction of the second diaphragm, respectively, and the second front cavity of the second speaker is in communication with the outside of the sound output device through a second sound guiding hole; a housing configured to accommodate the first speaker and the second speaker; and a support structure configured to place the housing at a position near an ear canal of a user without blocking an ear canal opening; wherein the first rear cavity is provided with a sound hole, one end of the sound hole is in communication with the first rear cavity, and the other end of the sound hole is in communication with the second front cavity, the first rear cavity and the second front cavity are communication with each other through the induction hole.

### BRIEF DESCRIPTION OF THE DRAWINGS

The present disclosure will be further illustrated by way of exemplary embodiments, which will be described in detail by means of the accompanying drawings.

These embodiments are not limiting, and in these embodiments, the same numbering denotes the same structure, wherein:

FIG. 1 is a frame diagram illustrating an exemplary sound output device according to some embodiments of the present disclosure;

FIG. 2 is a schematic diagram illustrating an exemplary frequency-dividing circuit according to some embodiments of the present disclosure;

FIG. 3 is a schematic diagram illustrating exemplary frequency division effects under different frequency division processing conditions according to some embodiments of the present disclosure;

FIG. 4 is a schematic diagram illustrating exemplary structures of a first speaker and a second speaker according to some embodiments of the present disclosure;

FIG. 5 is a schematic diagram illustrating an exemplary structure of a first speaker according to some embodiments of the present disclosure;

FIG. 6 is a schematic diagram illustrating exemplary structures of a first speaker and a second speaker according to some other embodiments of the present disclosure; and

FIG. 7 is a schematic diagram illustrating exemplary structures of another first speaker and another second speaker according to some embodiments of the present disclosure.

### DETAILED DESCRIPTION

To more clearly illustrate the technical solutions of the embodiments of the present disclosure, the accompanying drawings required to be used in the description of the embodiments will be briefly described below. Obviously, the accompanying drawings in the following description are only some examples or embodiments of the present disclosure, and it is possible for those skilled in the art to apply the present disclosure to other similar scenarios in accordance with these drawings without creative labor. Unless obviously obtained from the context or the context illustrates otherwise, the same numeral in the drawings refers to the same structure or operation.

It should be understood that, as used herein, “system,” “device,” “unit,” and/or “module” are used herein as a way to distinguish between different components, elements, parts, sections, or assemblies at different levels. However, the words may be replaced by other expressions if other words accomplish the same purpose.

As shown in the present disclosure and the claims, unless the context clearly suggests an exception, “a,” “an,” “one,” and/or “the” do not refer specifically to the singular, but also includes the plural. In general, the terms “include” and “comprise” only suggest the inclusion of explicitly identified operations and elements that do not constitute an exclusive list, and the method or device may also include other operations or elements.

Some embodiments of the present disclosure provide a sound output device including: a first speaker configured to generate a sound in a first frequency band in response to receiving a first electrical signal; a frequency-dividing circuit configured to perform a frequency division process on an excitation signal to generate the first electrical signal, and the frequency-dividing circuit is configured to: suppress signal components of the excitation signal with frequencies lower than a frequency-dividing frequency, so that a signal component of the first electrical signal with a frequency lower than a sound breaking frequency of the first speaker is attenuated by a preset amplitude compared to a signal component of the excitation signal with a frequency lower than the sound breaking frequency; a housing configured to accommodate the first speaker and the frequency-dividing circuit; and a support structure configured to place the housing at a position near an ear canal opening of a user without blocking the ear canal opening of the user.

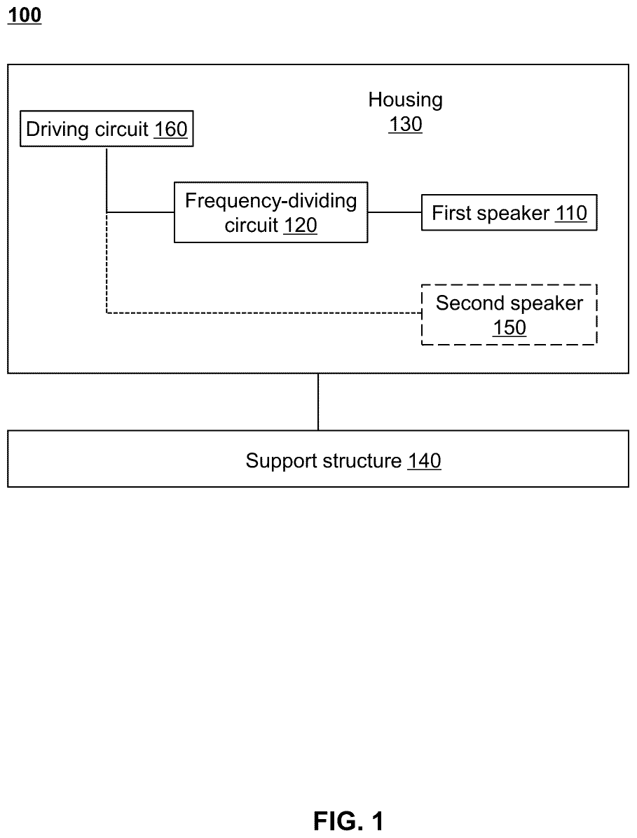

FIG. 1 is a frame diagram illustrating an exemplary sound output device according to some embodiments of the present disclosure.

As shown in FIG. 1, a sound output device 100 may include a first speaker 110, a frequency-dividing circuit 120, a housing 130, and a support structure 140.

The housing 130 is connected to the support structure 140 and configured to accommodate the first speaker 110 and the frequency-dividing circuit 120. In some embodiments, the housing 130 is a sealed housing structure with an accommodation cavity inside, and the first speaker 110 and the frequency-dividing circuit 120 are disposed within the accommodation cavity of the housing 130. In some embodiments, the sound output device 100 is a product or a combination of products, such as smart glasses, headphones, head-mounted display devices, AR/VR helmets, etc. In such cases, the sound output device 100 is fixedly placed near an auricle of a user in a hanging or clamping manner. In some alternative embodiments, a hanging structure (e.g., a hook) is provided on the housing 130. For example, a shape of the hook matches a shape of the auricle, and the sound output device 100 is worn independently on the auricle of the user via the hook.

In some embodiments, the housing 130 is a shell structure fitting a shape of a human ear, for example, a torus shape, an oval shape, a runway shape, a polygonal shape (regular or irregular), a U-shape, a V-shape, a semi-circular shape, and other regular or irregular shapes, so that the housing 130 can be directly hung on the ear of the user.

The support structure 140 is configured to place the housing 130 at a position near an ear canal opening of the user without blocking the ear canal opening, allowing the ear canal of the user to remain open. In such cases, the user can not only hear a sound output from the sound output device 100, but also obtain a sound from the external environment. For example, the sound output device 100 is provided around or partially around a circumference of the auricle of the user, and a sound transmission is achieved by means of air conduction or bone conduction. Exemplarily, the sound output device 100 is provided as an accessory of the smart glasses at a position of a temple, to surround or partially surround the circumference of the auricle of the user.

In some embodiments, depending on a type of the sound output device 100, the support structure 140 is different accordingly. Exemplarily, when the sound output device 100 is an earphone, the support structure 140 is an earhook; when the sound output device 100 is eyeglasses, the support structure 140 is a temple; when the sound output device 100 is a wristband, the support structure 140 is a loop strap; when the sound output device 100 is any other headsets, the support structure 140 is a helmet, etc.

In some embodiments, the first speaker 110 refers to an acoustic transducer with a better acoustic output performance in a range of a first frequency band, which improves the output performance of the sound output device 100 in the first frequency band. In some embodiments, the range of the first frequency band has different criteria based on actual situations. For example, the range of the first frequency band refers to a frequency range of no less than 5 kHz, such as 5 kHz-10 KHz, 8 KHz-16 kHz, etc.

In some embodiments, the sound output device 100 further includes a second speaker 150. The second speaker 150 refers to an acoustic transducer with a better acoustic output performance in a second frequency band to provide the sound output device 100 with a better output performance in the second frequency band. In some embodiments, a range of the second frequency band has different criteria based on actual situations. For example, the range of the second frequency band refers to a frequency range no higher than 5 kHz, such as 20 Hz-3 kHz, 100 Hz-5 kHz, etc.

In embodiments of the present disclosure, at least a portion of the frequency of the first frequency band is higher than the frequency of the second frequency band. For example, the range of the first frequency band is 5 kHz-20 KHz, and the range of the second frequency band is 20 Hz-6 KHz. Further example, the range of the first frequency band is 8 kHz-20 KHz, and the range of the second frequency band is 20 Hz-8.5 kHz. In some other embodiments, the first frequency band is also referred to as a high-frequency band, and the second frequency band is also referred to as a low-frequency band or a low-mid frequency band. For example, the first frequency band (the high-frequency band) and the second frequency band (the low-frequency band/the low-mid frequency band) refer to any two frequency bands with relatively different frequencies. For example, a frequency of the first frequency band is no less than 7 kHz, and a frequency of the second frequency band is less than 7 kHz.

In some embodiments, the sound output device 100 further includes a driving circuit 160. The driving circuit 160 is an electronic circuit for providing an excitation signal to the first speaker and the second speaker. In some embodiments, the excitation signal includes, for example, an electrical signal stored in the sound output device 100 or in a device communicatively connected to an outside of the sound output device. For example, the excitation signal is an electrical signal obtained from a multimedia platform, a terminal device, a storage device, etc. In some embodiments, the excitation signal is generated by a digital-to-analog converter. In some embodiments, an operation frequency band of the excitation signal includes 20 Hz-20 KHz or 20 Hz-16 kHz. In some embodiments, the operation frequency band of the excitation signal includes the first frequency band and the second frequency band as described previously. The electrical signal in the first frequency band of the excitation signal is also referred to as a high-frequency signal, and the electrical signal in the second frequency band of the excitation signal is also referred to as a low-frequency signal.

When the first speaker 110 and the second speaker 150 are driven simultaneously by the excitation signal, or when the first speaker 110 and the second speaker 150 are driven separately by the same excitation signal, since a first diaphragm (e.g., a first diaphragm 110-1) of the first speaker 110, which is mainly responsible for outputting sound of a higher frequency band (e.g., frequency bands included in the first frequency band), is usually thinner, there may be a sound break due to a too great amplitude when the first diaphragm receives a low-frequency signal (e.g., frequency bands included in the second frequency band), which affects the listening quality and user experience. To avoid the sound break of the sound output from the first speaker and to provide a better user experience, the electrical signal received by the first speaker 110 is processed by the frequency-dividing circuit 120 to avoid the first speaker 110 from receiving the electrical signal of a relatively low-frequency band (e.g., the second frequency band).

The frequency-dividing circuit 120 refers to an electronic circuit used for frequency division processing of the excitation signal. In some embodiments, the frequency-dividing circuit 120 is configured to perform the frequency division processing on the excitation signal to generate a first electrical signal input to the first speaker 110. At this point, the frequency-dividing circuit 120 is configured to suppress signal components of the excitation signal with frequencies lower than the frequency-dividing frequency. The first speaker 110 and the frequency-dividing circuit 120 can cooperate to enable the first speaker 110 to primarily output sound in the first frequency band. The frequency division processing includes a variety of manners, for example, a high-pass filtering, a band-pass filtering, a band-resistance filtering, etc. In some embodiments, the frequency-dividing circuit 120 generates a first electrical signal input to the first speaker 110 by performing a high-pass filtering process on the excitation signal.

The frequency-dividing frequency refers to a critical frequency at which the excitation signal is divided. For example, the frequency-dividing frequency is 8 kHz, and the frequency division processing of the frequency-dividing circuit 120 is to primarily suppress the signal components of the excitation signal with frequencies lower than 8 KHz. The frequency band where the aforementioned output sound of the first speaker 110 generates a sound break may be referred to as a sound breaking frequency band, and the maximum value of the frequency in the sound breaking frequency band may be referred to as a sound breaking frequency. In some embodiments, the sound breaking frequency of the first speaker is less than or equal to 200 Hz, i.e., the first speaker mainly generates the sound break in a frequency range less than 200 Hz. In some embodiments, the second frequency band includes the sound breaking frequency band.

In the embodiments of the present disclosure, by performing the frequency division processing on the excitation signal, the first electrical signal input to the first speaker 110 mainly includes the electrical signal of the first frequency band, and the first speaker 110 receives the first electrical signal to output the sound within the first frequency band, whereby the first speaker 110 is effectively prevented from receiving the electrical signal in a lower frequency band (e.g., the second frequency band), thereby avoiding the sound break in the sound output by the first speaker, and providing a better user experience. Meanwhile, the frequency-dividing circuit is set to effectively avoid the first speaker 110 from receiving the electrical signal of the lower frequency band (e.g., the second frequency band), thereby effectively avoiding the first speaker 110 from outputting the sound in the lower frequency band (e.g., the second frequency band) and effectively reducing the power consumption of the first speaker 110.

In some embodiments, according to an operation principle, a type of the second speaker 150 or the first speaker 110 includes, but is not limited to, a moving coil transducer, a moving iron transducer, a flat plate transducer, a piezoelectric transducer, etc. The moving coil transducer has a higher transduction efficiency, a higher sensitivity, and a better general sound quality, but has a poorer output effect in the first frequency band. The moving iron transducer has a higher sensitivity, but a flat range of its frequency response curve is smaller, and the structure of the moving iron transducer is precise, costly, narrow, and long, which is difficult to design. The piezoelectric transducer has a higher transducer efficiency and higher sensitivity, but requires a high voltage to drive a piezoelectric member, and a frequency response curve of the piezoelectric transducer is not flat in the first frequency band, and a vibration mode of the piezoelectric transducer has a great range of peaks and valleys. The diaphragm of the flat plate transducer is more uniformly stressed everywhere, which better avoids a generation of a segmented vibration, and thus better avoids a distortion of the output sound, and makes the output effect better in the range of the first frequency band.

Based on the foregoing analysis, in some embodiments, the second speaker 150 adopts the moving coil transducer to enable the second speaker 150 to have a better acoustic output in the range of the second frequency band. In some embodiments, the first speaker 110 adopts the flat plate transducer to give the first speaker 110 a better acoustic output in the range of the first frequency band.

In some embodiments, the second speaker 150 primarily generate the sound in the second frequency band in response to a second electrical signal. In some embodiments, the excitation signal is directly input into the second speaker 150 as the second electrical signal, such that the second speaker 150 has a higher output in the second frequency band while also being able to have a certain output in the first frequency band, so as to supplement the output of the first speaker 110 in the first frequency band, and improve an output performance of the sound output device 100 in the first frequency band. In some embodiments, the second electrical signal is also the electrical signal after the excitation signal is low-pass filtered.

In some embodiments, the sound output device also includes another frequency-dividing circuit (not shown in the figures), the other frequency-dividing circuit is configured to perform low-pass filtering on the excitation signal to generate the second electrical signal and to input the low-pass filtered second electrical signal into the second speaker 150.

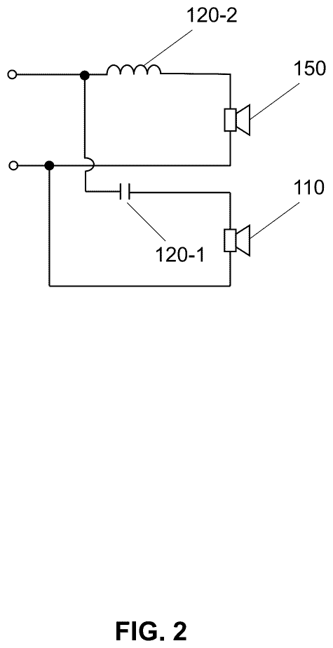

As shown in FIG. 2, in some embodiments, the frequency-dividing circuit 120 includes a capacitive element 120-1 provided in series with the first speaker 110, and the high-pass filtering on the excitation signal is realized by the capacitive element 120-1 to generate the first electrical signal, and the high-pass filtered first electrical signal is input to the first speaker 110; the other frequency-dividing circuit includes an inductive element 120-2 provided in series with the second speaker 150, through which the inductive element 120-2 realizes the low-pass filtering of the excitation signal to generate the second electrical signal, and the second electrical signal formed after low-pass filtering is input to the second speaker 150. In some embodiments, the low-pass filtering is used to attenuate an amplitude of a component of the first frequency band in the excitation signal.

It is appreciated that in some embodiments of the present disclosure, the frequency-dividing circuit 120 and another frequency-dividing circuit are provided separately or assembled in the same processing circuit or the same processor, and the present disclosure does not specifically limit the form thereof.

In some embodiments, the first speaker mainly experiences sound break in a frequency range below 200 Hz. To avoid the sound break in the first speaker 110, it is necessary to attenuate a signal component of the first electrical signal received by the first speaker 110 that is below the sound breaking frequency (e.g., 200 Hz). The greater an attenuation degree of the signal component with the frequency lower than the sound breaking frequency in the first electrical signal received by the first speaker 110, the lower the probability of the first speaker 110 generating the sound break in the frequency band below the sound breaking frequency. To better avoid the occurrence of the sound break in the second frequency band of the first speaker 110, in some embodiments, by performing frequency division processing on the excitation signal, the frequency-dividing circuit 120 makes the signal component of the generated first electrical signal with the frequency lower than the sound breaking frequency attenuated by a preset amplitude compared to the signal component of the excitation signal with the frequency lower than the sound breaking frequency. The preset amplitude may be a preset value, a user input value, etc. In some embodiments, to reduce the probability for the first speaker 110 to experience the sound break in the second frequency band, the preset amplitude is greater than or equal to 20 dB, and the second frequency band includes the sound breaking frequency of the first speaker 110. In some embodiments, to further reduce the probability of the first speaker 110 experiencing the sound break in the second frequency band, the preset amplitude is greater than or equal to 30 dB. In some embodiments, to further reduce the probability of the first speaker 110 to experience the sound break in the second frequency band, the preset amplitude is greater than or equal to 40 dB, at which time the first speaker outputs less or no sound below the sound breaking frequency, and the sound in this frequency band is mainly output by the second speaker, thereby avoiding an interference of the sound output.

In some embodiments, to make the attenuation degree of the signal component with the frequency lower than the sound breaking frequency in the first electrical signal received by the first speaker 110 greater, the frequency-dividing frequency is selected to be farther away from the sound breaking frequency (e.g., 200 Hz) of the first speaker 110. For example, the frequency-dividing frequency is five octaves away from the sound breaking frequency of the first speaker 110. Exemplarily, a frequency point of 200 Hz is used as the sound breaking frequency of the first speaker 110, the frequency-dividing frequency is correspondingly located near (200×2⁵) Hz, i.e., the frequency-dividing frequency includes 6.4 kHz. In some embodiments, if the frequency-dividing frequency is too great, the component of the first frequency band in the first electrical signal obtained by frequency-dividing can be reduced, which affects a normal output of the first speaker 110, and thus the octave between the frequency-dividing frequency and the sound breaking frequency of the first speaker 110 should not be too great. In some embodiments, the octave between the frequency-dividing frequency and the sound breaking frequency of the first speaker 110 is no more than 6 octaves, i.e., the frequency-dividing frequency is no more than (200×2⁶) Hz, correspondingly, i.e., the frequency-dividing frequency is no greater than 12.8 kHz. In some embodiments, in order to further ensure the component of the first frequency band in the first electrical signal to ensure the output of the first speaker 110, the frequency-dividing frequency is in a range of 6 kHz-9 kHz. In some embodiments, in order to further reduce the component of the second frequency band in the first electrical signal, the frequency-dividing frequency is in a range of 7.5 kHz-8.5 kHz. For example, the frequency-dividing frequency is 8 KHz.

In some embodiments, the frequency-dividing frequency is obtained by detecting the electrical signal after it passes through the frequency-dividing circuit but before being input to the first speaker 110. In some embodiments, when the excitation signal adopts a sweep signal, on a frequency response curve of the first electrical signal obtained after the frequency division processing, the frequency corresponding to an inflection point on the frequency response curve is the frequency-dividing frequency, indicating a change in an attenuation amplitude of the first electrical signal before and after the inflection point. For example, for the first electrical signal processed by the high-pass filtering, the attenuation amplitude of a portion of the frequency response curve before the inflection point becomes greater (greater than the attenuation amplitude of an original excitation signal), and the farther away from the inflection point, the greater the attenuation amplitude; and the attenuation amplitude of the portion of the frequency response curve after the inflection point is roughly similar to the attenuation amplitude of the original excitation signal.

In some embodiments, a plurality of digital-to-analog converters are provided in the sound output device 100 to generate the excitation signal of the first frequency band and the excitation signal of the second frequency band. By inputting the excitation signal of the first frequency band into the first speaker 110 and inputting the excitation signal of the second frequency band into the second speaker 150, the first speaker 110 is prevented from sound breaking at the second frequency band. However, setting up the plurality of digital-to-analog converters not only increases the manufacturing cost of the sound output device 100, but also increases the volume of a finished product of the sound output device 100. Therefore, to reduce the manufacturing cost and the volume of the finished product of the sound output device 100, in some embodiments, the sound output device 100 may be provided with only one digital-to-analog converter for outputting a single excitation signal, and the excitation signal simultaneously excites the first speaker 110 and the second speaker 150. To avoid a situation where the first speaker 110 receives the signal in the second frequency band and causes the sound breaking in the second frequency band, the frequency-dividing circuit 120 may perform the frequency division process on the excitation signal output by the digital-to-analog converter. More content about the second speaker may be found in the related description later.

FIG. 2 is a schematic diagram illustrating an exemplary frequency-dividing circuit according to some embodiments of the present disclosure.

As shown in FIG. 2, the frequency-dividing circuit 120 includes the capacitive element 120-1 connected in series with the first speaker 110. The frequency-dividing circuit 120 generates a first electrical signal by high-pass filtering an excitation signal through the capacitive element 120-1.

In some embodiments, there is one capacitive element 120-1 connected in series with the first speaker 110. One capacitive element 120-1 forms a first-order high-pass filter that performs a first-order frequency division process on the excitation signal to generate the first electrical signal. In some embodiments, there are a plurality of capacitive elements 120-1 connected in series with the first speaker 110, e.g., 2, 3, etc. The plurality of capacitive elements 120-1 and other electronic elements (e.g., an amplifier, a resistor, etc.) may form a multi-order high-pass filter to perform a multi-order frequency division process on the excitation signal to generate the first electrical signal.

In some embodiments, the higher the order of the high-pass filtering, the faster the signal component in the excitation signal of the frequency band corresponding to the frequency below the frequency-dividing frequency attenuates. Considering a greater octave between the frequency-dividing frequency and a sound breaking frequency (e.g., 200 Hz) of the first speaker 110, to attenuate the signal components in the first electrical signal with frequencies lower than the sound breaking frequency by a preset amplitude compared to the signal components in the excitation signal with frequencies lower than the sound breaking frequency, the frequency-dividing circuit 120 may employ the first-order high-pass filter or the multi-order high-pass filter. In some embodiments, to simplify the circuit and reduce the complexity of the system, and to ensure a normal output of the first speaker 110, when the frequency-dividing frequency is in a range of 6 kHz-9 kHz, the frequency-dividing circuit 120 adopts the first-order high-pass filtering, i.e., there is one capacitive element 120-1 connected in series with the first speaker 110.

In some embodiments, when the frequency-dividing circuit 120 employs the first-order high-pass filtering, the capacitance value of the capacitive element 120-1 in series with the first speaker 110 is correlated with the frequency-dividing frequency of the frequency division process.

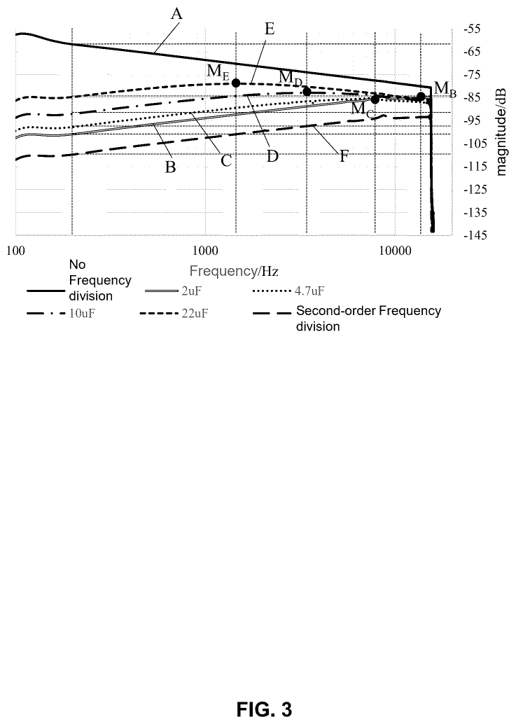

FIG. 3 is a schematic diagram illustrating exemplary frequency division effects under different frequency division processing conditions according to some embodiments of the present disclosure. As shown in FIG. 3, curve A is a curve of an excitation signal without frequency division processing, curve B is a curve of a first electrical signal generated by utilizing a series-connected capacitive element with a capacitance value of 2 μF for frequency-dividing, curve C is a curve of a first electrical signal generated after frequency division processing using a series-connected capacitive element with a capacitance value of 4.6 μF, curve D is a curve of a first electrical signal generated after frequency division processing using a series-connected capacitive element with a capacitance value of 10 μF, curve E is a curve of a first electrical signal generated after frequency division processing using a series-connected capacitive element with a capacitance value of 22 μF, and curve F is a curve of a first electrical signal generated after frequency division processing using two series-connected capacitive elements.

In some embodiments, the capacitance value of the capacitive element 120-1 connected in series with the first speaker 110 is correlated with the frequency-dividing frequency. In some embodiments, the capacitance value of the capacitive element 120-1 corresponds to a theoretical frequency-dividing frequency:

$$C = \frac{1}{2 π {f}_{c} {z}_{0}} , \qquad ( 1 )$$

where C denotes the capacitance value of the capacitive element; f_{c} denotes the frequency-dividing frequency for the frequency division processing; and Z₀ denotes a rated impedance of the first speaker. It is understood that when there are a plurality of capacitive elements 120-1 connected in series with the first speaker 110, the capacitance value calculated by formula (1) is an equivalent capacitance value of the plurality of capacitive elements 120-1.

As there is a magnetic circuit assembly and a voice coil in the structure of the first speaker 110, the voice coil receives the first electrical signal and moves relative to the magnetic circuit assembly, thereby driving the first diaphragm 110-1 to vibrate to generate sound. The voice coil in the circuit acts as an inductor to affect the frequency-dividing frequency, resulting in the actual frequency-dividing frequency deviating from the theoretical frequency-dividing frequency. As shown in FIG. 3, the actual frequency-dividing frequency corresponding to the curve B (i.e., the frequency corresponding to an extreme value point MB of curve B) is near 15 kHz, the actual frequency-dividing frequency corresponding to the curve C (i.e., the frequency corresponding to an extreme value point MC of the curve C) is near 8 kHz, the actual frequency-dividing frequency corresponding to the curve D (i.e., the frequency corresponding to an extreme value point MD of the curve D) is near 3.4 kHz, and the actual frequency-dividing frequency corresponding to curve E is near 1.5 kHz. Combining formula (1) with curves C, D, and E, it can be seen that the actual frequency-dividing frequency is negatively correlated with the capacitance value of the capacitive element 120-1.

Please refer to FIG. 3, near 200 Hz, curve A corresponds to a frequency response amplitude of about −62 dB, curve B corresponds to a frequency response amplitude of about −101 dB, curve C corresponds to a frequency response amplitude of about −98 dB, curve D corresponds to a frequency response amplitude of about −92 dB, and curve E corresponds to a frequency response amplitude of about −85 dB. That is, compared to the curve A representing the excitation signal without frequency division processing, an amplitude of the signal component below 200 Hz in the first electrical signal corresponding to the curve B is attenuated by approximately 39 dB, an amplitude of the signal component below 200 Hz in the first electrical signal corresponding to the curve C is attenuated by approximately 36 dB; an amplitude of the signal component below 200 Hz in the first electrical signal corresponding to the curve D is attenuated by approximately 30 dB; an amplitude of the signal component below 200 Hz in the first electrical signal corresponding to the curve E is attenuated by approximately 23 dB. That is, compared to the excitation signal without frequency division processing (corresponding to the curve A), the amplitude attenuation of the signal components below 200 Hz in the first electrical signal (corresponding to the curves B, C, D, and E) obtained by performing the frequency division processing on the excitation signal utilizing one capacitive element is relatively large. In this way, low-frequency components in the excitation signal are effectively suppressed, and the first electrical signal after the frequency division processing can effectively reduce the generation of the sound break of the first speaker 110.

In addition, compared to the first electrical signal obtained by the first-order frequency division processing utilizing one capacitive element (corresponding to the curves B, C, D, and E), the first electrical signal after the second-order frequency division processing utilizing two capacitive elements attenuates the signal components below 200 Hz in the first electrical signal (corresponding to the curve F) by a greater magnitude, and has a better frequency division effect. As shown in FIG. 3, near 200 Hz, the curve F corresponds to a frequency response amplitude of about −110 dB. That is, compared to the curve A representing the excitation signal without frequency division processing, the curve F corresponds to an amplitude attenuation of the signal component below 200 Hz in the first electrical signal by about 48 dB, demonstrating that the second-order frequency division processing avoids the sound break of the first speaker 110 to a greater extent. However, the attenuation amplitude of a portion of the curve F at the high frequencies (e.g., above 8 kHz) is also relatively large, and the attenuation amplitude of the signal components at the mid-high frequencies (e.g., the first frequency band) in the first electrical signal correspondingly obtained by the second-order frequency division processing is also relatively large, which affects a normal output of the first speaker 110 in the first frequency band. Moreover, using two capacitive elements can result in a more complex structure of the frequency-dividing circuit 120, and also increases the volume of an electronic component accommodating the frequency-dividing circuit 120, which results in an increase in manufacturing cost and the volume of the ultimately produced sound output device 100. In summary, for simplifying the circuit and reducing the complexity of the system, and to ensure that the first speaker 110 outputs normally in the first frequency band, the frequency-dividing circuit 120 may adopt the first-order high-pass filtering, that is, one capacitive element 120-1 is connected in series with the first speaker 110.

By comparing the curve B, the curve C, the curve D, and the curve E, it can be seen that the higher the frequency-dividing frequency, the greater the amplitude attenuation of the signal component in the corresponding first electrical signal below 200 Hz, and the better the frequency division effect. However, when the frequency-dividing frequency is too high, the component of the first frequency band in the first electrical signal obtained after frequency division processing is reduced, which affects the normal output of the first speaker 110 in the first frequency band. Therefore, to ensure the frequency division effect and at the same time avoid affecting the normal output of the first speaker 110 in the first frequency band, the frequency-dividing frequency needs to be limited. In some embodiments, the frequency-dividing frequency is in a range of 6 kHz-9 KHz.

In combination with the capacitive elements connected in series by the curve B, the curve C, the curve D, and the curve E, the smaller the capacitance value of a single capacitive element, the higher the corresponding frequency-dividing frequency, the greater the attenuation magnitude of the signal component below 200 Hz in the first electrical signal, and the better the frequency division effect. However, when the capacitance value of the series-connected capacitive element is too small, the frequency-dividing frequency may be too high, and the component in the first frequency band of the first electrical signal obtained after the frequency division processing is reduced, which is likely to affect the normal output of the first speaker 110 at the first band. Therefore, to ensure the frequency division effect and at the same time avoid affecting the normal output of the first speaker 110 in the first frequency band, the capacitance value of the capacitive element needs to be limited.

In some embodiments, if there is one capacitive element 120-1 connected in series with the first speaker 110, to improve the frequency division effect while ensuring the normal output of the first speaker 110 in the first frequency band, the capacitance value of the capacitive element 120-1 is in a range of 4.2 μF-5.2 μF. In some embodiments, to further improve the frequency division effect while ensuring the normal output of the first speaker 110, the capacitance value of the capacitive element 120-1 is in a range of 4.4 μF-5.0 μF. In some embodiments, to further improve the frequency division effect while ensuring the normal output of the first speaker 110, the capacitance value of the capacitive element 120-1 is in a range of 4.5 μF-4.8 μF.

Referring to the curves A, B, C, D, and E in FIG. 3, in the curves B, C, D, and E of the first electrical signal after the frequency division processing, the frequency corresponding to the inflection point is the corresponding frequency-dividing frequency, and the portion of the curves before the inflection points gradually attenuates, and the farther from the inflection point, the greater the attenuate amplitude; and the portion of the curves after the inflection point basically maintains an attenuation amplitude similar to the attenuation amplitude of the excitation signal without the frequency division processing (the curve A). In the curve B, the frequency response amplitude at the frequency-dividing frequency (15 kHz) is about −85 dB, and the signal component at 200 Hz is attenuated by about 16 dB compared to the signal component at the frequency-dividing frequency (15 kHz); the frequency response amplitude of the signal component at the frequency point (400 kHz) five octaves away from the frequency-dividing frequency (15 kHz) is about −98 dB, and the signal component at the frequency point (400 kHz) is attenuated by about 13 dB compared to the signal component at the frequency-dividing frequency (15 kHz); the frequency response amplitude of the signal component at the frequency point (800 kHz) four octaves away from the frequency-dividing frequency (15 kHz) is about −95 dB, and the signal component at the frequency point (800 kHz) is attenuated by about 10 dB compared to the signal component at the frequency-dividing frequency (15 kHz); the frequency response amplitude of the signal component at the frequency point (1.6 kHz) three octaves away from the frequency-dividing frequency (15 kHz) is about −92 dB, and the signal component at the frequency point (1.6 kHz) is attenuated by about 7 dB compared to the signal component at the frequency-dividing frequency (15 kHz). In the curve C, the frequency response amplitude at the frequency-dividing frequency (8 kHz) is about −85.5 dB, and the signal component at 200 Hz is attenuated by about 15.5 dB compared to the signal component at the frequency-dividing frequency (8 kHz); the frequency response amplitude of the signal component at the frequency point (250 Hz) five octaves away from the frequency-dividing frequency (8 kHz) is about −97 dB, and the signal component at the frequency point (250 Hz) is attenuated by about 11.5 dB compared to the signal component at the frequency-dividing frequency (8 kHz); the frequency response amplitude of the signal component at the frequency point (500 Hz) four octaves away from the frequency-dividing frequency (8 kHz) is about −94 dB, and the signal component at the frequency point (500 Hz) is attenuated by about 8.5 dB compared to the signal component at the frequency-dividing frequency (8 kHz); the frequency response amplitude of the signal component at the frequency point (1 kHz) three octaves away from the frequency-dividing frequency (8 kHz) is about −91 dB, and the signal component at the frequency point (1 kHz) is attenuated by about 4.5 dB compared to the signal component at the frequency-dividing frequency (8 kHz); the frequency response amplitude of the signal component at the frequency point (2 kHz) two octaves away from the frequency-dividing frequency (8 kHz) is about −88.3 dB, and the signal component at the frequency point (2 kHz) is attenuated by about 2.8 dB compared to the signal component at the frequency-dividing frequency (8 kHz). In the curve D, the frequency response amplitude at the frequency-dividing frequency (3.4 kHz) is about-83 dB, and the signal component at 200 Hz is attenuated by about 9 dB compared to the signal component at the frequency-dividing frequency (e.g., 3.4 kHz); the frequency response amplitude of the signal component at the frequency point (200 Hz) four octaves away from the frequency-dividing frequency (3.4 kHz) is about −92 dB, and the signal component at the frequency point (200 Hz) is attenuated by about 9 dB compared to the signal component at the frequency-dividing frequency (8 kHz); the frequency response amplitude of the signal component at the frequency point (400 Hz) three octaves away from the frequency-dividing frequency (3.4 kHz) is about −89 dB, and the signal component at the frequency point (400 Hz) is attenuated by about 6 dB compared to the signal component at the frequency-dividing frequency (8 kHz); the frequency response amplitude of the signal component at the frequency point two octaves away (850 Hz) away from the frequency-dividing frequency (3.4 kHz) is about −86 dB, and the signal component at the frequency point (850 Hz) is attenuated by about 3 dB compared to the signal component at the frequency-dividing frequency (3.4 kHz). In the curve E, the frequency response amplitude at the frequency-dividing frequency (1.5 kHz) is about −79 dB, and the signal component at 200 Hz is attenuated by about 6 dB compared to the signal component at the frequency-dividing frequency (e.g., 1.5 kHz); the frequency response amplitude of the signal component at the frequency point (180 Hz) three octaves away from the frequency-dividing frequency (1.5 kHz) is about −85.1 dB, and the signal component at the frequency point (180 Hz) is attenuated by about 6.1 dB compared to the signal component at the frequency-dividing frequency (e.g., 1.5 kHz); the frequency response amplitude of the signal component at the frequency point (375 Hz) two octaves away from the frequency-dividing frequency (1.5 kHz) is about −82 dB, and the signal component at the frequency point (375 Hz) is attenuated by about 3 dB compared to the signal component at the frequency-dividing frequency (e.g., 1.5 kHz); the frequency response amplitude of the signal component at the frequency point (750 Hz) one octave away from the frequency-dividing frequency (1.5 kHz) is about −80 dB, and the signal component at the frequency point (750 Hz) is attenuated by about 1 dB compared to the signal component at the frequency-dividing frequency (e.g., 1.5 kHz). In summary, in the first electrical signal obtained after the frequency division processing, the signal component at the frequency point with the greater octave from the frequency-dividing frequency is attenuated by a greater magnitude compared to the signal component at the frequency-dividing frequency. In addition, the signal component with the frequency lower than the sound breaking frequency has a greater attenuation amplitude compared to the signal component at the frequency-dividing frequency, i.e., the amplitude of the signal component in the second frequency band (e.g., a frequency band below 200 Hz in the second frequency band) farther away from the frequency-dividing frequency is relatively small, and the first electrical signal obtained after the frequency division processing has fewer components below the sound breaking frequency, i.e., there are fewer signal components in the second frequency band received by the first speaker 110, so as to effectively avoid the sound break of the first speaker 110.

In some embodiments, to avoid the sound breaking of the first speaker 110 in the second frequency band, the signal component with a frequency lower than the sound breaking frequency of the first speaker 110 in the first electrical signal is attenuated by at least 30 dB compared to the signal component at the frequency-dividing frequency. In some embodiments, to further reduce the probability of the first speaker 110 experiencing the sound breaking in the second frequency band, the signal component with the frequency lower than the sound breaking frequency in the first electrical signal is attenuated by at least 35 dB compared to the signal component at the frequency-dividing frequency. In some embodiments, to further reduce the probability of the first speaker 110 experiencing the sound breaking in the second frequency band, the signal component with the frequency lower than the sound breaking frequency in the first electrical signal is attenuated by at least 40 dB compared to the signal component at the frequency-dividing frequency.

In some embodiments of the present disclosure, by setting the frequency-dividing frequency range and the capacitance value range of the capacitive element to the foregoing ranges, the amplitude attenuation of the component in the second frequency band in the first electrical signal generated by the frequency-dividing circuit after the frequency division processing on the excitation signal is made to be more effective, and the first speaker is prevented from sound breaking as much as possible. At the same time, the component of the first frequency band is retained as much as possible in the first electrical signal after the frequency division processing, thereby ensuring the normal output of the first speaker.

It should be understood that the frame diagram provided in FIG. 1 is provided for illustrative purposes only and is not intended to limit the scope of the present disclosure. For those skilled in the art, various deformations and modifications may be made under the guidance of the present disclosure, and these deformations and modifications fall within the scope of protection of the present disclosure. In some embodiments, the count of components shown in FIG. 1 may be adjusted according to actual situations. In some embodiments, one or more elements shown in FIG. 1 may be omitted, or one or more other elements may be added or removed. For example, the support structure 140 is not included in the sound output device 100, and the housing 130 has a wearing fixation function of the support structure 140. In some embodiments, one element may be replaced by other elements that perform similar functions. In some embodiments, one element may be split into a plurality of sub-elements, or a plurality of elements may be combined into a single element. For example, the housing 130 and the support structure 140 are combined into a single element.

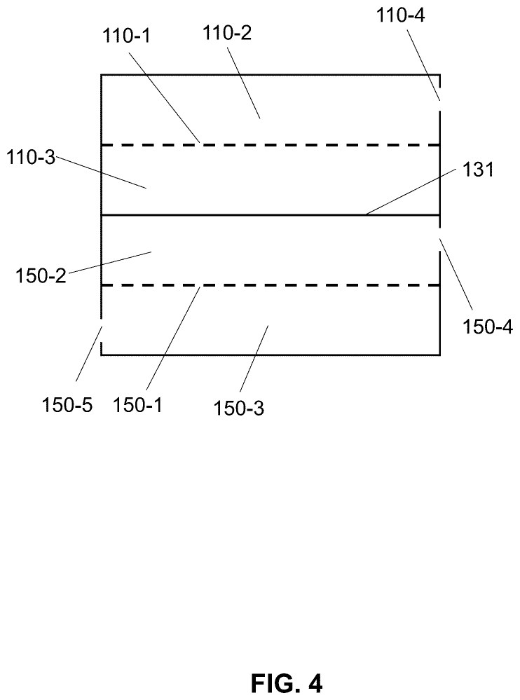

FIG. 4 is a schematic diagram illustrating exemplary structures of a first speaker and a second speaker according to some embodiments of the present disclosure.

As shown in FIG. 4, the first speaker 110 includes the first diaphragm 110-1. The first front cavity 110-2 and the first rear cavity 110-3 are respectively disposed on both sides of the first diaphragm 110-1 along a vibration direction of the first diaphragm 110-1, respectively. The first front cavity 110-2 of the first speaker is connected to the outside of the sound output device through a first sound guiding hole 110-4. The second speaker 150 includes a second diaphragm 150-1. A second front cavity 150-2 and a second rear cavity 150-3 are disposed on both sides of the second diaphragm 150-1 along a vibration direction of the second diaphragm 150-1, respectively, and the second front cavity 150-2 of the second speaker 150 is connected to the outside of the sound output device through a second sound guiding hole 150-4.

In some embodiments, the first speaker 110 radiates sound to the exterior of the housing 130 through the first sound guiding hole 110-4, and in the wearing state, the first sound guiding hole 110-4 corresponding to the first speaker 110 faces an ear canal opening of the user (i.e., the first sound guiding hole 110-4 is disposed in a sidewall of the housing 130 facing the ear canal opening of the user in the wearing state). By disposing the first sound guiding hole 110-4 toward the ear canal opening of the user, a listening effect of the ear of the user to the sound output by the first speaker 110 is improved, so as to make it possible to receive a greater sound volume at the ear canal opening of the user, and enable the user to obtain a clear sound. By disposing the first speaker 110 and the corresponding first sound guiding hole 110-4, an output sound pressure level of the sound output device 100 in the first frequency band (e.g., 8 kHz-16 kHz) may be improved, thereby ensuring an output effect of the sound output device 100 in the first frequency band.

In some embodiments, the second speaker 150 radiates sound to the exterior of the housing 130 through the second sound guiding hole 150-4, and in the wearing state, the second sound guiding hole 150-4 corresponding to the second speaker 150 faces the ear canal opening of the user.

In some embodiments, the second rear cavity 150-3 of the second speaker 150 is provided with a third sound guiding hole 150-5, through which the second rear cavity 150-3 is in communication with the outside of the sound output device. The second sound guiding hole 150-4 is in communication with the second front cavity 150-2 and guides the sound generated by the second front cavity 150-2 out of the housing 130 and then transmits the sound toward the ear canal of the user to enable the user to hear the sound. In some embodiments, the second sound guiding hole 150-4 and the third sound guiding hole 150-5 are disposed on both sides of the second diaphragm 150-1 of the second speaker 150, respectively, and the third sound guiding hole 150-5 is disposed relatively away from the ear canal opening of the user. Merely by way of example, as shown in FIG. 4, the second sound guiding hole 150-4 is disposed on a sidewall of the second front cavity 150-2 of the second speaker 150 facing the of the ear canal opening of the user, and the third sound guiding hole 150-5 is provided on the sidewall of the second rear cavity 150-3 of the second speaker 150 departs from the ear canal opening of the user, so that the sound output device 100, in the wearing state, has the second sound guiding hole 150-4 facing the ear canal opening of the user, and the third sound guiding hole 150-5 departs from the ear canal opening of the user.

In some embodiments, a portion of the sound guided through the second sound guiding hole 150-4 propagates to the ear canal so that the user hears the sound, and another portion of the sound guided through the second sound guiding hole 150-4 propagates with the sound reflected by the ear canal to the outside of the sound output device 100 and the outside of the ear through a gap between the housing 130 and the ear, thereby generating a first sound leakage in a far field; at the same time, the third sound guiding hole 150-5 provided on other side surfaces of the housing 130 (e.g., a side surface away from or depart from the ear canal of the user) are farther away from the ear canal compared to the second sound guiding hole 150-4, and the sound propagated by the third sound guiding hole 150-5 generally forms a second sound leakage in the far field. An intensity of the first sound leakage is comparable to an intensity of the second sound leakage and a phase of the first sound leakage and a phase of the second sound leakage are (proximity) opposite to each other, such that the first sound leakage and the second sound leakage cancel each other in the far field, which is conducive to realizing a sound leakage reduction effect of the sound output device 100 in low and middle frequency bands (e.g., the second frequency band), so that the sound output device 100 is dipole directional in the low and middle frequency bands.

In some embodiments, as shown in FIG. 4, the first rear cavity 110-3 of the first speaker 110 does not in communication with the outside of the sound output device, and the first rear cavity 110-3 is separated from the second front cavity 150-2 by a spacer 131 such that the first rear cavity 110-3 does not in communication with the second front cavity 150-2. In some embodiments, a magnetic conductor in the structure of the first speaker 110 acts as the spacer 131 to separate the first rear cavity 110-3 from the second front cavity 150-2. By separating the first rear cavity 110-3 from the second front cavity 150-2 using the spacer 131, the transmission of sound from the second front cavity 150-2 to the first rear cavity 110-3 is avoided, or the transmission of sound from the first rear cavity 110-3 to the second front cavity 150-2 is avoided, so as to minimize the mutual interference of the sound generated by the first speaker 110 and the sound generated by the second speaker 150, thereby improving the quality of a full-band output of the sound output device 100.

In some embodiments, when the first rear cavity 110-3 is closed, during a vibration process of the first diaphragm 110-1, as the first front cavity 110-2 is in communication with the outside of the sound output device through the first sound guiding hole 110-4, and the first rear cavity 110-3 does not in communication with the outside of the sound output device, the first front cavity 110-2 and the first rear cavity 110-3 are unbalanced in terms of air pressure, resulting in an unbalanced vibration of the first diaphragm 110-1 and an excessive amplitude, leading to a sound break of the first speaker 110. In some embodiments, to reduce the occurrence of the above situation, a sound hole 110-5 is provided on the first rear cavity 110-3 of the first speaker 110, and the first rear cavity 110-3 is in communication with the outside of the sound output device through the sound hole 110-5.

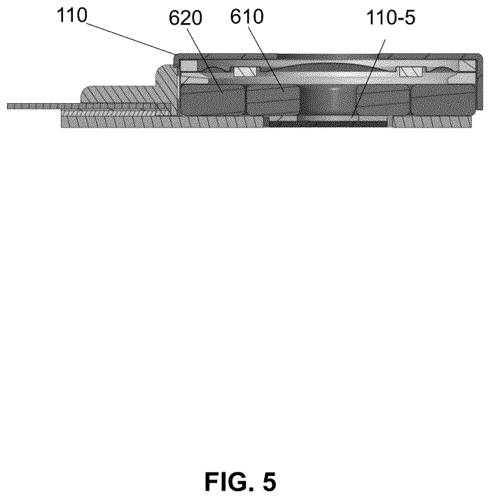

FIG. 5 is a schematic diagram illustrating an exemplary structure of a first speaker according to some embodiments of the present disclosure. In some embodiments, as shown in FIG. 5, the first rear cavity 110-3 of the first speaker 110 includes an inner magnet 610 and an outer magnet 620 that surrounds the inner magnet 610. In some embodiments, the sound hole 110-5 penetrates the inner magnet 610 to allow the first rear cavity 110-3 to be in communication with the outside of the sound output device through the sound hole 110-5.

When the aperture of the sound hole 110-5 is set too great, the volume and an effective magnetic area of the inner magnet 610 may be too small, which affects the strength of the magnetic field of the inner magnet 610 at the voice coil, thereby affecting the output of the sound output device 100. When the aperture of the sound hole 110-5 is set too small, a machining process may be too difficult, and the airtightness may be poorer. Therefore, in some embodiments, to reduce a process difficulty and at the same time to ensure the magnetic field strength of the inner magnet 610 to ensure the output of the sound output device 100, the aperture of the sound hole 110-5 is in a range of 0.3 mm-0.8 mm. In some embodiments, to further reduce the process difficulty, the aperture of the sound hole 110-5 is in a range of 0.4 mm-0.7 mm. In some embodiments, to further ensure the magnetic field strength of the inner magnet 610, the aperture of the sound hole 110-5 is in a range of 0.45 mm-0.6 mm.

In some embodiments, to reduce the process difficulty and at the same time to ensure the magnetic field strength of the inner magnet 610 to ensure the output of the sound output device 100, a ratio of an opening area of the sound hole 110-5 to an area of the inner magnet 610 is in a range of 0.02-0.08. In some embodiments, to further reduce the process difficulty, the ratio of the opening area of the sound hole 110-5 to the area of the inner magnet 610 is in a range of 0.03-0.07. In some embodiments, the ratio of the opening area of the sound hole 110-5 to the area of the inner magnet 610 is in a range of 0.04-0.06. As used herein, the opening area of the sound hole 110-5 is an area of an opening of the sound hole 110-5 in an axial direction of the sound hole 110-5, and the area of the inner magnet 610 is a projection area of the inner magnet 610 along the axial direction of the sound hole 110-5.

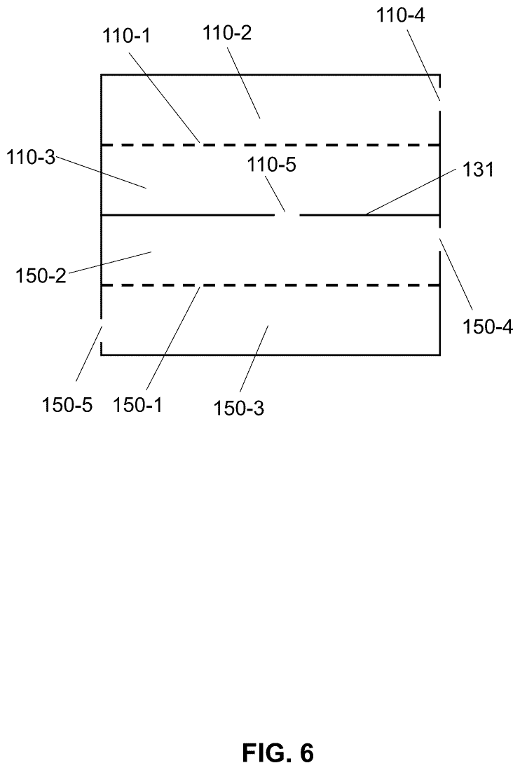

FIG. 6 is a schematic diagram illustrating exemplary structures of a first speaker and a second speaker according to some other embodiments of the present disclosure. A difference between the sound output device 100 illustrated in FIG. 6 and the sound output device 100 illustrated in FIG. 4 is that the first rear cavity 110-3 is in communication with the second front cavity 150-2 of the second speaker 150 through the sound hole 110-5, and as the second front cavity 150-2 is in communication with the outside of the sound output device, the first rear cavity 110-3 is made to be in communication with the outside of the sound output device as well, so as to equalize an air pressure of the first rear cavity 110-3 of the first speaker 110 with an air pressure of the first front cavity 110-2, and to ensure a vibration balance of the first diaphragm 110-1 of the first speaker 110, so as to effectively solve a problem of sound break when the first speaker 110 receives the input signal in the second frequency band.

In some embodiments, as the first rear cavity 110-3 of the first speaker 110 is in communication with the second front cavity 150-2 of the second speaker 150 through the sound hole 110-5, a sound in the first rear cavity 110-3 propagates to the second front cavity 150-2 through the sound hole 110-5, or the sound in the second front cavity 150-2 propagates through the sound hole 110-5 to the first rear cavity 110-3. If the acoustic resistance of the sound hole 110-5 is too small, it may cause a significant interference between the sound generated by the first speaker 110 and the sound generated by the second speaker 150. If the acoustic resistance of the sound hole 110-5 is too great, an air pressure in the first rear cavity 110-3 and an air pressure in the first front cavity 110-2 may not be balanced well. In some embodiments, to minimize an interference between the sound generated by the first speaker 110 and the sound generated by the second speaker 150, and at the same time, to make the air pressure in the first front cavity 110-2 and the air pressure in the first rear cavity 110-3 balanced well, the acoustic resistance of the sound hole 110-5 is in a range of 5×10⁸ Pa·s/m−1.3×10⁹ Pa·s/m. In some embodiments, to further avoid the interference between the sound generated by the first rear cavity 110-3 and the sound generated by the second front cavity 150-2, the acoustic resistance of the sound hole 110-5 is in a range of 7×10⁸ Pa·s/m−1×10⁹ Pa·s/m. In some embodiments, to further enable a better balance of the air pressure in the first front cavity 110-2 and the air pressure in the first rear cavity 110-3, the acoustic resistance of the sound hole 110-5 is in a range of 8×10⁸ Pa·s/m−9×10⁸ Pa·s/m. The acoustic resistance of the sound hole 110-5 may be measured based on a national group standard T/CECA 79-2023 by “Acoustic impedance measurement methods of waterproof membrane die-cut parts for electroacoustic transducers,” which is not excessively limited or described in the present disclosure.

In some embodiments, an acoustic impedance mesh is provided on a circumferential wall or an outer sidewall of the sound hole 110-5 to adjust an acoustic resistance of the sound hole 110-5. The outer sidewall of the sound hole 110-5 is a sidewall surface facing the second front cavity 150-2 of the second speaker 150.

When the aperture of the sound hole 110-5 is set too great, the sound resistance of the sound hole 110-5 is too small, making it unable to efficiently avoid the mutual interference of the sounds generated by the first rear cavity 110-3 and the second front cavity 150-2. When the aperture of the sound hole 110-5 is set too small, an airflow difficulty is increased, which results in an excessive sound resistance of the sound hole 110-5, and it may be unable to well balance the sound pressure of the first rear cavity 110-3 and the sound pressure of the front cavity 110-2. Accordingly, in some embodiments, to provide the sound hole 110-5 with a suitable sound resistance, the aperture of the sound hole 110-5 may be in a range of 0.95 mm-1.1 mm.

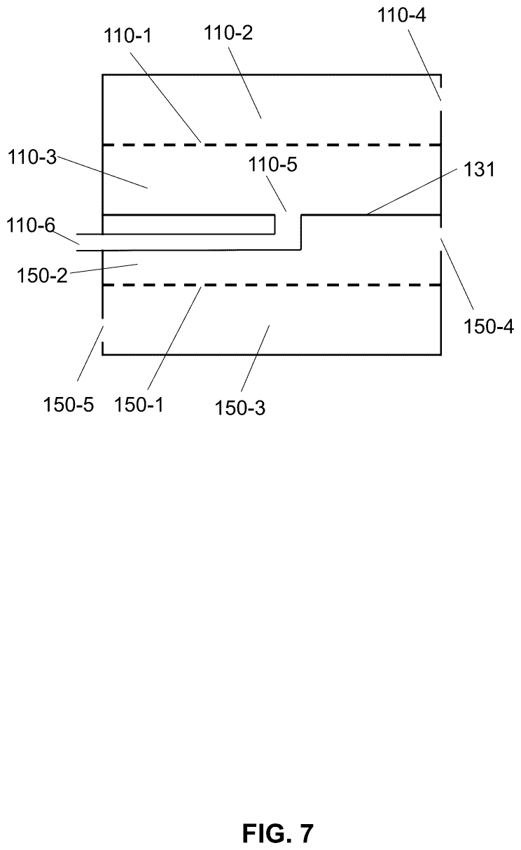

FIG. 7 is a schematic diagram illustrating exemplary structures of another first speaker and another second speaker according to some embodiments of the present disclosure.

In some embodiments, to achieve an air pressure balance between the first rear cavity 110-3 and the first front cavity 110-2 and to avoid a mutual interference of the sounds generated by the first rear cavity 110-3 and the second front cavity 150-2, as shown in FIG. 7, the first rear cavity 110-3 of the first rear cavity 110 of the speaker 110 is provided with the sound hole 110-5. One end of the sound hole 110-5 is in communication with the first rear cavity 110-3, and the other end of the sound hole 110-5 is provided with a sound guiding tube 110-6. The first rear cavity 110-3 is in communication with the outside of the sound output device through the sound guiding tube 110-6, and a sound guiding channel of the sound guiding tube 110-6 is isolated from the second front cavity 150-2.

In some embodiments of the present disclosure, by providing the sound guiding tube in the first rear cavity, the first rear cavity of the first speaker is allowed to be in communication with the outside of the sound output device, so as to equalize the air pressure in the first rear cavity of the first speaker with the air pressure in the first front cavity, thereby allowing for a balanced vibration of the first diaphragm of the first speaker. In this way, the problem of sound breaking of the first speaker in the second frequency band is solved. At the same time, as the sound guiding channel of the sound guiding tube is isolated from the second front cavity, the sound generated by the first rear cavity and the sound generated by the second front cavity do not cause the problem of mutual interference.

In some embodiments, when using the frequency-dividing circuit 120 to perform a frequency division process on an excitation signal, the first rear cavity 110-3 is in communication with the outside of the sound output device through the sound guiding hole 110-5, so as to further solve the problem of the sound breaking of the first speaker 110 receiving the second frequency band of the input signal.

The basic concepts have been described above, and it is obvious to those skilled in the art that the above detailed disclosure serves only as an example and does not constitute a limitation of the present disclosure. Although not explicitly stated here, those skilled in the art may make various modifications, improvements, and amendments to the present disclosure. These modifications, improvements and amendments are intended to be suggested by the present disclosure, and are within the spirit and scope of the exemplary embodiments of the present disclosure.

Moreover, certain terminology has been used to describe embodiments of the present disclosure. For example, “an embodiment,” “one embodiment,” and/or “some embodiments” mean a feature, structure, or characteristic associated with at least one embodiment of the present disclosure. Accordingly, it should be emphasized and noted that two or more references to “one embodiment” or “an embodiment” in different positions in the present disclosure do not necessarily refer to the same embodiment. In addition, some features, structures, or characteristics in one or more embodiments of the present disclosure may be appropriately combined.

Similarly, it should be appreciated that in the foregoing description of embodiments of the present disclosure, various features are sometimes grouped together in a single embodiment, figure, or description thereof for the purpose of streamlining the disclosure and aiding in the understanding of one or more of the various embodiments. However, this does not mean that the object of the present disclosure requires more features than the features mentioned in the claims. Rather, claimed subject matter may lie in less than all features of a single foregoing disclosed embodiment.

Some embodiments use numbers describing the number of components, attributes, and it should be understood that such numbers used in the description of embodiments, in some examples, use the modifiers “about,” “approximately,” or “generally” for decoration. Unless otherwise noted, the terms “about,” “approximately,” or “generally” indicates that a ±20% variation in the stated number is allowed. Correspondingly, in some embodiments, the numerical parameters used in the present disclosure and the claims are approximations, which change depending on the desired characteristics of individual embodiments. In some embodiments, the numerical parameters should take into account the specified number of valid digits and employ general place-keeping. While the numerical domains and parameters used to confirm the breadth of their ranges in some embodiments of the present disclosure are approximations, in specific embodiments such values are set to be as precise as possible within a feasible range.

At last, it should be understood that the embodiments described in the present disclosure are merely illustrative of the principles of the embodiments of the present disclosure. Other modifications employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

1. A sound output device, comprising:
a first speaker configured to generate a sound in a first frequency band in response to receiving a first electrical signal;
a frequency-dividing circuit configured to perform a frequency division process on an excitation signal to generate the first electrical signal, and the frequency-dividing circuit is configured to:
suppress signal components of the excitation signal with frequencies lower than a frequency-dividing frequency, so that a signal component of the first electrical signal with a frequency lower than a sound breaking frequency of the first speaker is attenuated by a preset amplitude compared to a signal component of the excitation signal with the frequency lower than the sound breaking frequency;
a housing configured to accommodate the first speaker and the frequency-dividing circuit; and
a support structure configured to place the housing at a position near an ear canal opening of a user without blocking the ear canal opening of the user.

2. The sound output device of claim 1, wherein the signal component of the first electrical signal with the frequency lower than the sound breaking frequency is attenuated by at least 30 dB compared to a signal component of the first electrical signal at the frequency-dividing frequency.

3. The sound output device of claim 1, wherein the sound breaking frequency is less than or equal to 200 Hz.

4. The sound output device of claim 1, wherein the preset amplitude is greater than or equal to 20 dB.

5. The sound output device of claim 1, wherein the frequency-dividing frequency is in a range of 6 kHz-9 KHz.

6. The sound output device of claim 5, wherein the frequency-dividing frequency is in a range of 7.5 kHz-8.5 KHz.

7. The sound output device of claim 6, wherein the frequency-dividing circuit includes a capacitive element connected in series with the first speaker, the capacitive element having a capacitance value in a range of 4.2 μF-5.2 μF.

8. The sound output device of claim 1, further comprising:
a second speaker configured to generate a sound in a second frequency band, a frequency of the second frequency band being less than a frequency of the first frequency band; wherein
the first speaker includes a first diaphragm, a first front cavity and a first rear cavity are disposed on both sides of the first diaphragm along a vibration direction of the first diaphragm, respectively, and the first front cavity of the first speaker is in communication with an outside of the sound output device through a first sound guiding hole; and
the second speaker includes a second diaphragm, a second front cavity and a second rear cavity are disposed on both sides of the second diaphragm along a vibration direction of the second diaphragm, respectively, and the second front cavity of the second speaker is in communication with the outside of the sound output device through a second sound guiding hole.

9. The sound output device of claim 8, wherein the first speaker is accommodated in the housing, the first rear cavity of the first speaker is sealed, and the first rear cavity is separated from the second front cavity by a partition.

10. The sound output device of claim 8, wherein the first rear cavity of the first speaker is provided with a sound hole, and the first rear cavity is in communication with the outside of the sound output device through the sound hole.

11. The sound output device of claim 10, wherein an aperture of the sound hole is in a range of 0.3 mm-0.8 mm.

12. The sound output device of claim 10, wherein the first rear cavity is provided with an inner magnet, the sound hole penetrates the inner magnet to make the first rear cavity be in communication with the outside of the sound output device through the sound hole, and a ratio of an opening area of the sound hole to an area of the inner magnet is in a range of 0.02-0.08.

13. The sound output device of claim 12, wherein one end of the sound hole is in communication with the first rear cavity, and the other end of the sound hole is in communication with the second front cavity.

14. The sound output device of claim 13, wherein a circumferential sidewall or an outer sidewall of the sound hole is provided with an acoustic resistance mesh, and a sound resistance of the sound hole is in a range of 5×10⁸ Pa·s/m−1.3×10⁹ Pa·s/m.

15. The sound output device of claim 10, wherein
one end of the sound hole is in communication with the first rear cavity,
the other end of the sound hole is provided with a sound guiding tube,
the first rear cavity is in communication with the outside of the sound output device through the sound guiding tube, and
a sound guiding channel of the sound guiding tube is isolated from the second front cavity.

16. The sound output device of claim 8, wherein the second speaker generates the sound in the second frequency band in response to a second electrical signal, the second electrical signal including the excitation signal, or a signal formed after performing a low-pass filtering on the excitation signal.

17. A sound output device, comprising:
a first speaker configured to output a sound of a first frequency band, the first speaker including a first diaphragm, wherein a first front cavity and a first rear cavity are disposed on both sides of the first diaphragm along a vibration direction of the first diaphragm, respectively, and the first front cavity of the first speaker is in communication with an outside of the sound output device through a first sound guiding hole;
a second speaker configured to output a sound of a second frequency band, a frequency of the second frequency band being smaller than a frequency of the first frequency band, a second front cavity and a second rear cavity are disposed on both sides of the second diaphragm along a vibration direction of the second diaphragm, respectively, and the second front cavity of the second speaker is in communication with the outside of the sound output device through a second sound guiding hole;
a housing configured to accommodate the first speaker and the second speaker; and
a support structure configured to place the housing at a position near an ear canal of a user without blocking an ear canal opening; wherein
the first rear cavity is provided with a sound hole, one end of the sound hole is in communication with the first rear cavity, and the other end of the sound hole is in communication with the second front cavity.

18. The sound output device of claim 1, wherein the frequency-dividing frequency is five octaves away from the sound breaking frequency of the first speaker.

19. The sound output device of claim 1, wherein the frequency-dividing circuit adopts a first-order high-pass filtering.

20. The sound output device of claim 17, wherein an aperture of the sound hole is in a range of 0.95 mm-1.1 mm.
